(19) United States
(12) Patent Application Publication
(10) Pub. No.: US 2012/0049686 A1
(43) Pub. Date: Mar. 1, 2012

(54) ROTARY ELECTRIC MACHINE

(75) Inventor: Kosuke MIZUIKE, Kyoto (JP)

(73) Assignee: NIDEC CORPORATION, Kyoto (JP)

(21) Appl. No.: 13/215,289

(22) Filed: Aug. 23, 2011

(30) Foreign Application Priority Data
Aug. 27, 2010 (JP) 2010-190487

(51) Int. Cl. H02K 1/27; H02K 1/28

(52) U.S. Cl. 310/156.53; 310/216.004

(57) ABSTRACT

A rotating portion of a rotary electric machine includes a shaft arranged to extend along a central axis, and a rotor core fixed to the shaft. The rotor core includes a through hole group including a plurality of through holes extending through the rotor core in an axial direction. The through hole group is arranged not to be symmetrical with respect to any imaginary plane including the central axis.

### BACKGROUND OF THE INVENTION

1. Field of the Invention

The present invention relates to a rotary electric machine.

2. Description of the Related Art

In known inner-rotor motors, a rotor core that holds a magnet is arranged to rotate inside of electromagnetic coils. In a typical inner-rotor motor, the rotor core is substantially columnar in shape. The rotor core is, for example, defined by laminated electromagnetic steel sheets. In addition, the rotor core includes a through hole defined in a center thereof. A shaft is press fitted into the through hole, so that the rotor core and the shaft are fixed to each other. In some cases, it is necessary to press fit the shaft into the through hole through a predetermined one of upper and lower surfaces of the rotor core.

For instance, in the case where the central through hole of the rotor core is defined by a stamping process, edge portions of the through hole on both the upper and lower surfaces of the rotor core may undergo slight deformations during the stamping process. In this case, it is desirable that the direction in which the shaft is press fitted into the through hole coincides with the direction of stamping process used in making the laminated electromagnetic steel sheets.

In the case where the shaft is press fitted into the through hole in a direction opposite to a predetermined direction, greater stresses are applied to the shaft and the rotor core than in the case where the shaft is press fitted into the through hole in the predetermined direction. This may cause damage in the rotor core or the shaft, and also may cause a reduction in positional accuracy or dimensional accuracy of each component after the press fit is completed. This may in turn cause a reduction in rotational accuracy of the shaft.

In order to press fit the shaft into the through hole of the rotor core in the predetermined direction, it is necessary to distinguish between the upper and lower surfaces of the rotor core.

### SUMMARY OF THE INVENTION

According to a preferred embodiment of the present invention, a rotary electric machine includes a stationary portion and a rotating portion supported to be rotatable with respect to the stationary portion. The rotating portion preferably includes a shaft arranged to extend along a central axis extending in a vertical direction; a rotor core fixed to the shaft and defined by sheets laminated in an axial direction (i.e., radially extending sheets axially stacked on one another); and rotor magnets held by the rotor core. The stationary portion preferably includes a bearing portion arranged to support the shaft such that the shaft is rotatable, and an armature arranged radially outward of the rotor magnets. The rotor core includes a through hole group including a plurality of through holes extending through the rotor core in the axial direction. The through hole group is arranged not to be symmetrical with respect to any imaginary plane that includes the central axis.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a vertical cross-sectional view of a rotary electric machine according to a preferred embodiment of the present invention.

FIG. 2 is a top view of a rotor core according to a preferred embodiment of the present invention.

FIG. 3 is a vertical cross-sectional view of a motor according to a preferred embodiment of the present invention.

FIG. 4 is an enlarged vertical cross-sectional view illustrating a central portion of an upper end portion of a rotor core according to a preferred embodiment of the present invention.

FIG. 5 is an enlarged vertical cross-sectional view illustrating a central portion of a lower end portion of the rotor core.

FIG. 6 is a top view of the rotor core.

FIG. 7 is a diagram illustrating how an upper surface and a lower surface of the rotor core are distinguished by using a jig.

FIG. 8 is a top view of a rotor core according to an example modification of a preferred embodiment of the present invention.

FIG. 9 is a top view of a rotor core according to another example modification of a preferred embodiment of the present invention.

FIG. 10 is a top view of a rotor core according to yet another example modification of a preferred embodiment of the present invention.

FIG. 11 is a top view of a rotor core according to yet another example modification of a preferred embodiment of the present invention.

FIG. 12 is a top view of a rotor core according to yet another example modification of a preferred embodiment of the present invention.

FIG. 13 is a top view of a rotor core according to yet another example modification of a preferred embodiment of the present invention.

FIG. 14 is a top view of a rotor core according to yet another example modification of a preferred embodiment of the present invention.

FIG. 15 is a top view of a rotor core according to yet another example modification of a preferred embodiment of the present invention.

### DETAILED DESCRIPTION OF THE PREFERRED EMBODIMENTS

Hereinafter, preferred embodiments of the present invention will be described with reference to the accompanying drawings. It is assumed hereinafter that a vertical direction is defined as a direction in which a central axis of a rotary electric machine extends. The shape of each member or portion and relative positions of different members or portions will be described based on this assumption. It should be noted, however, that the above definition of the vertical direction is made merely for the sake of convenience in description, and should not be construed to restrict the orientation of the rotary electric machine when in actual use.

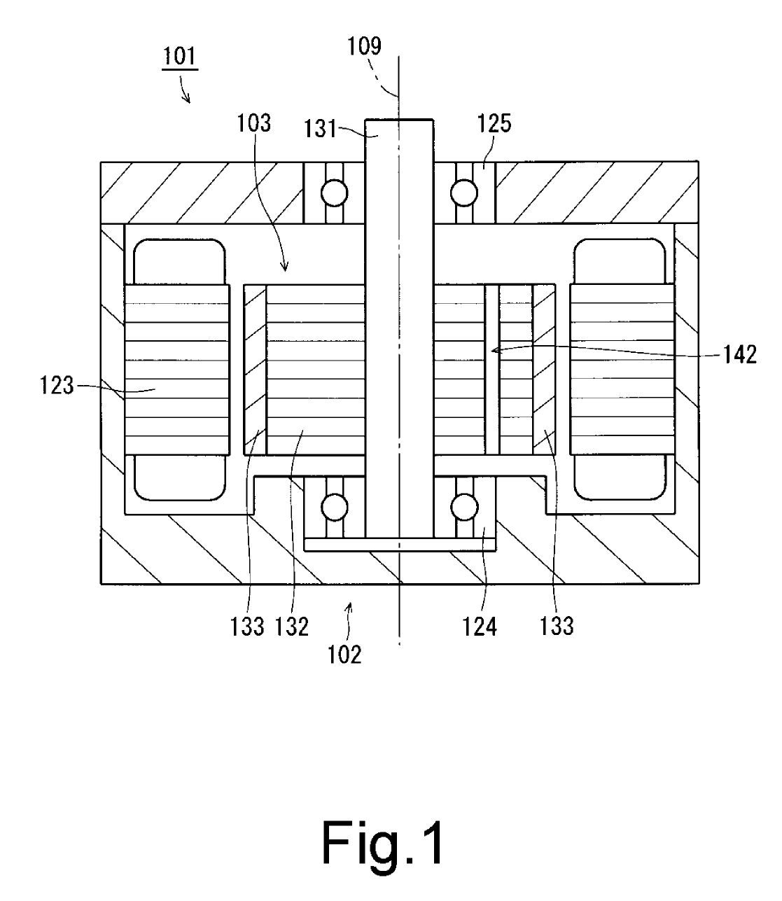

FIG. 1 is a vertical cross-sectional view of a rotary electric machine 101 according to a preferred embodiment of the present invention. As illustrated in FIG. 1, the rotary electric machine 101 includes a stationary portion 102 and a rotating portion 103. The rotating portion 103 arranged to be rotatably supported with respect to the stationary portion 102.

The rotating portion 103 preferably includes a shaft 131, a rotor core 132, and a rotor magnet 133. A central axis 109 is arranged to extend in the vertical direction. The shaft 131 is arranged to extend along the central axis 109. The rotor core 132 is arranged to be fixed to the shaft 131. The rotor core 132 is preferably defined by a plurality of steel sheets laminated in an axial direction (i.e., radially extending sheets axially stacked on one another). The rotor magnet 133 is held by the rotor core 132. The terms “axial direction”, “axial”, and “axially” as used herein refer to a direction along the central axis.

The stationary portion preferably 102 includes a plurality of bearing portions and an armature 123. In this preferred embodiment, the stationary portion 102 preferably includes two bearing portions 124 and 125. Each of the bearing portions 124 and 125 is arranged to play a role in supporting the shaft 131 such that the shaft 131 is rotatable. The armature 123 is arranged radially outward of the rotor magnet 133. The terms “radial direction”, “radial”, and “radially” as used herein refer to directions perpendicular to the central axis.

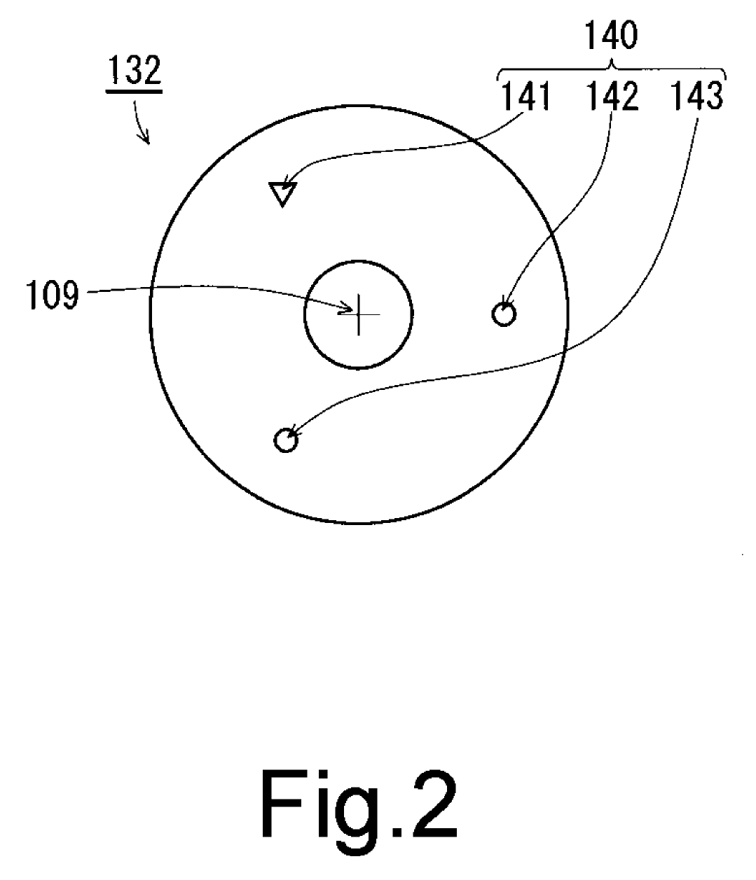

FIG. 2 is a top view of the rotor core 132. As illustrated in FIG. 2, the rotor core 132 includes a through hole group 140. The through hole group 140 preferably includes a plurality of through holes 141, 142, and 143 extending through the rotor core 132 in the axial direction. The through hole group 140 is arranged such that it will not be symmetrical with respect to any imaginary plane including the central axis 109. Therefore, the configurations of the through hole group 140 on upper and lower surfaces of the rotor core 132 do not coincide with each other. In a process of manufacturing the rotary electric machine 101, the through hole group 140 is used to preferably enable a manufacturer, an assembly machine, or the like to distinguish between the upper and lower surfaces of the rotor core 132. This makes it possible to insert the shaft 131 into the rotor core 132 in an appropriate direction.

Next, the specific structure of a preferred embodiment will now be described below.

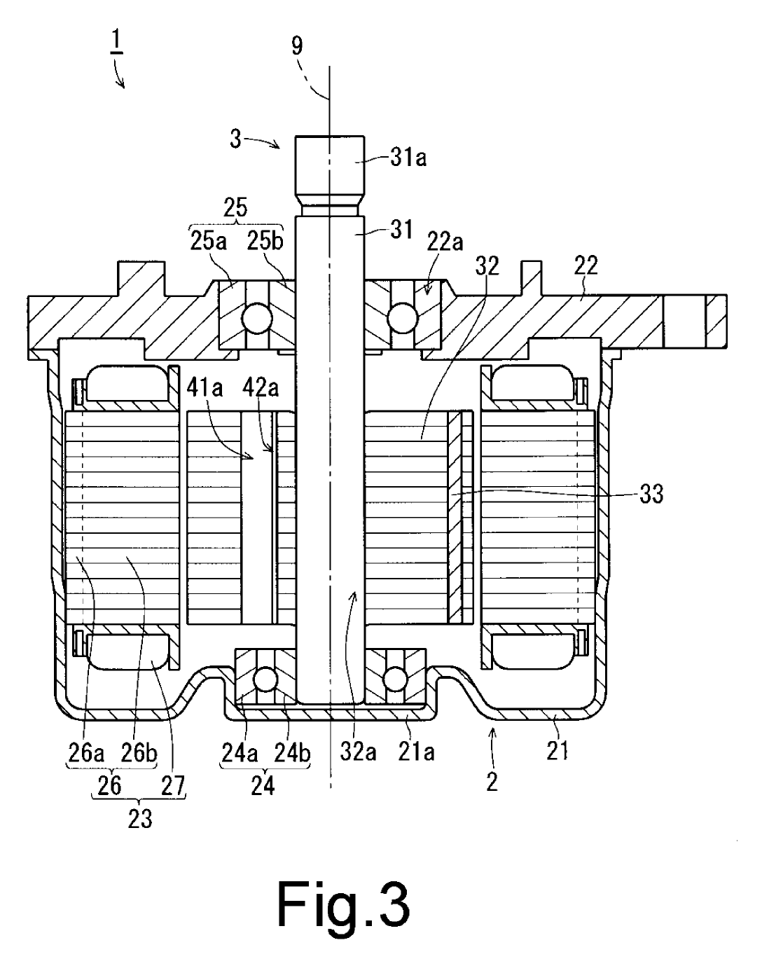

FIG. 3 is a vertical cross-sectional view of a motor 1, which is a rotary electric machine according to a preferred embodiment of the present invention. As illustrated in FIG. 3, the motor 1 includes a stationary portion 2 and a rotating portion 3. The rotating portion 3 is supported to be rotatable with respect to the stationary portion 2.

The stationary portion 2 preferably includes a housing 21, a cover portion 22, an armature 23, a lower bearing portion 24, and an upper bearing portion 25.

The housing 21 is preferably a casing that has a bottom and which is substantially cylindrical. The housing 21 is preferably arranged to accommodate the armature 23, the lower bearing portion 24, and the rotating portion 3 therein. The housing 21 includes a recessed portion 21a defined in a center of a bottom portion thereof. The recessed portion 21a is arranged to hold the lower bearing portion 24. The cover portion 22 is a member in the shape of a flat plate. The cover portion 22 is arranged to close an upper opening of the housing 21. The cover portion 22 includes a circular hole 22a defined in a center thereof. The circular hole 22a is arranged to hold the upper bearing portion 25.

The armature 23 preferably includes a stator core 26 and coils 27. The armature 23 is arranged to generate magnetic flux in accordance with drive currents supplied to the coils 27. The stator core 26 includes a core back 26a and a plurality of teeth 26b. The core back 26a is in a substantially annular shape and centered on a central axis 9. The teeth 26b are arranged at regular intervals in a circumferential direction, and arranged to project radially inward from the core back 26a.

The stator core 26 is fixed to an inner circumferential surface of a side wall of the housing 21. The stator core 26 and the housing 21 are fixed to each other preferably through, for example, an adhesive or press fitting, for example. Note that the stator core 26 and the housing 21 may alternatively be fixed to each other by other desirable methods. In the present preferred embodiment, the stator core 26 preferably includes a plurality of electromagnetic steel sheets laminated in the axial direction. Note that the stator core 26 may alternatively be formed by other desirable methods. A conducting wire is wound around each of the teeth 26b to define the coils 27.

Each of the lower and upper bearing portions 24 and 25 is preferably arranged to support a shaft 31. In the present preferred embodiment, each of the lower and upper bearing portions 24 and 25 is preferably a ball bearing. The lower bearing portion 24 includes an outer race 24a, an inner race 24b, and balls. The upper bearing portion 25 includes an outer race 25a, an inner race 25b, and balls.

The outer race 24a is fixed to the recessed portion 21a. The outer race 25a is fitted and thereby fixed to the circular hole 22a. Meanwhile, each of the inner races 24b and 25b is fixed to the shaft 31. The shaft 31 is thereby supported to be rotatable with respect to the housing 21 and the cover portion 22.

Note that any other desirable bearing mechanisms other than the ball bearings may be used for the lower and upper bearing portions 24 and 25. For example, each of the lower and upper bearing portions 24 and 25 may alternatively be a sintered bearing or a fluid bearing.

The rotating portion 3 includes the shaft 31, a rotor core 32, and a plurality of rotor magnets 33.

The shaft 31 is substantially in the shape of a column, and arranged to extend in the vertical direction along the central axis 9. As described above, the shaft 31 is supported by the lower and upper bearing portions 24 and 25 such that the shaft 31 is rotatable about the central axis 9. The shaft 31 includes a head portion 31a arranged to project above the cover portion 22. The head portion 31a is connected to a driven portion through a power transmission mechanism. Examples of the power transmission mechanism include, for example, a gear, a pulley, and a chain. Examples of the driven portion include a wheel.

The rotor core 32 is a member fixed to the shaft 31 and arranged to rotate together with the shaft 31. The rotor core 32 preferably includes an outer circumferential surface extending in the axial direction substantially in the shape of a cylinder. The rotor core 32 includes a central through hole 32a defined in a center thereof. The shaft 31 is inserted into the central through hole 32a. In the present preferred embodiment, the rotor core 32 is defined by a plurality of electromagnetic steel sheets laminated in the axial direction. Note that the rotor core 32 may be defined by other methods.

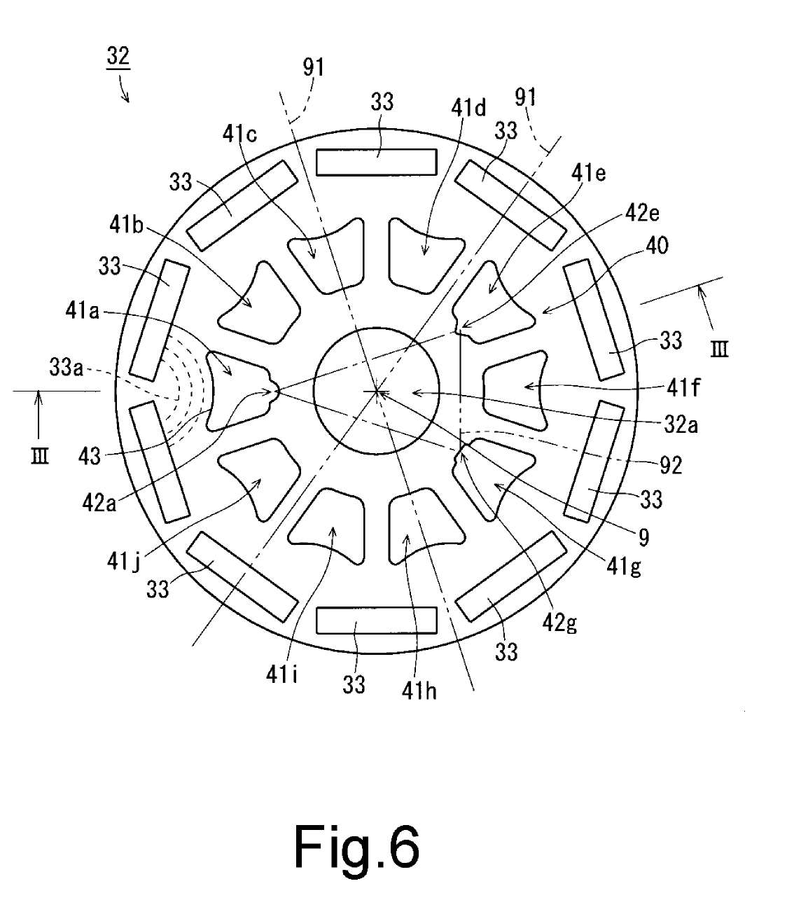

The rotor core 32 includes a plurality of through holes defined therein. The through holes are preferably arranged at regular intervals in the circumferential direction and centered on the central axis 9. The through holes are arranged in the vicinity of the outer circumferential surface of the rotor core 32. Each of the rotor magnets 33 is embedded in a separate one of the through holes. Each of a radially outer surface and a radially inner surface of each rotor magnet 33 defines a north or south magnetic pole. Referring to FIG. 6, the rotor magnets 33 are arranged in the circumferential direction to thereby assume the shape of a ring. In the rotor core 32, the north and south magnetic poles of the rotor magnets 33 are arranged to alternate with each other in the circumferential direction. The armature 23 is arranged radially outward of the rotor magnets 33. The armature 23 is arranged radially opposite the radially outer pole surfaces of the rotor magnets 33.

Once the drive currents are supplied to the coils 27, magnetic flux is generated around the teeth 26b. Then, the magnetic flux generated around the coils 27 interact with magnetic flux generated around the rotor magnets 33 to generate a circumferential torque between the teeth 26b and the rotor magnets 33. As a result, the rotating portion 3 is caused to rotate about the central axis 9 with respect to the stationary portion 2. Rotation of the rotating portion 3 is transmitted to the driven portion through the power transmission mechanism.

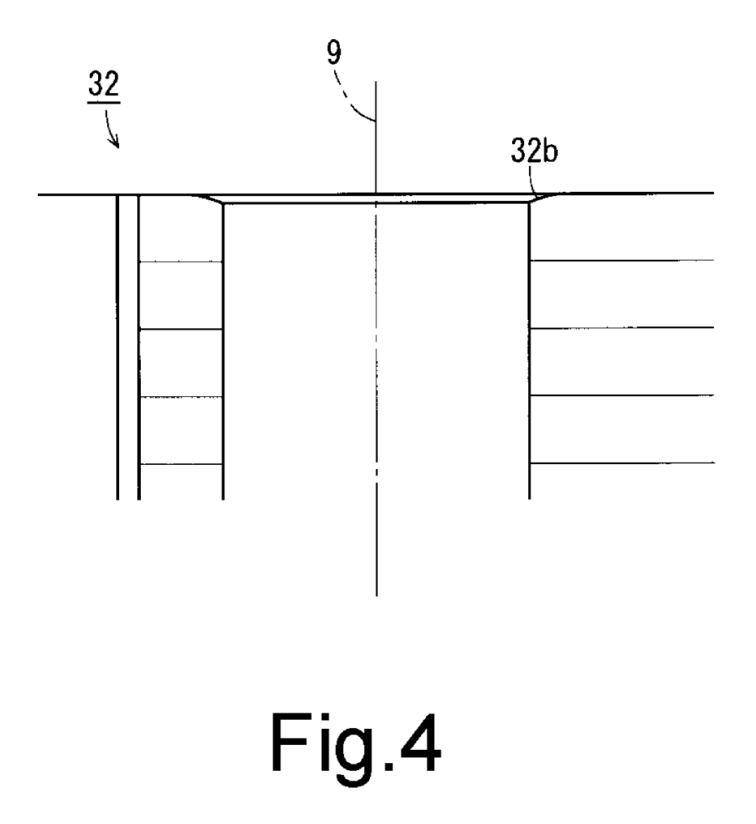

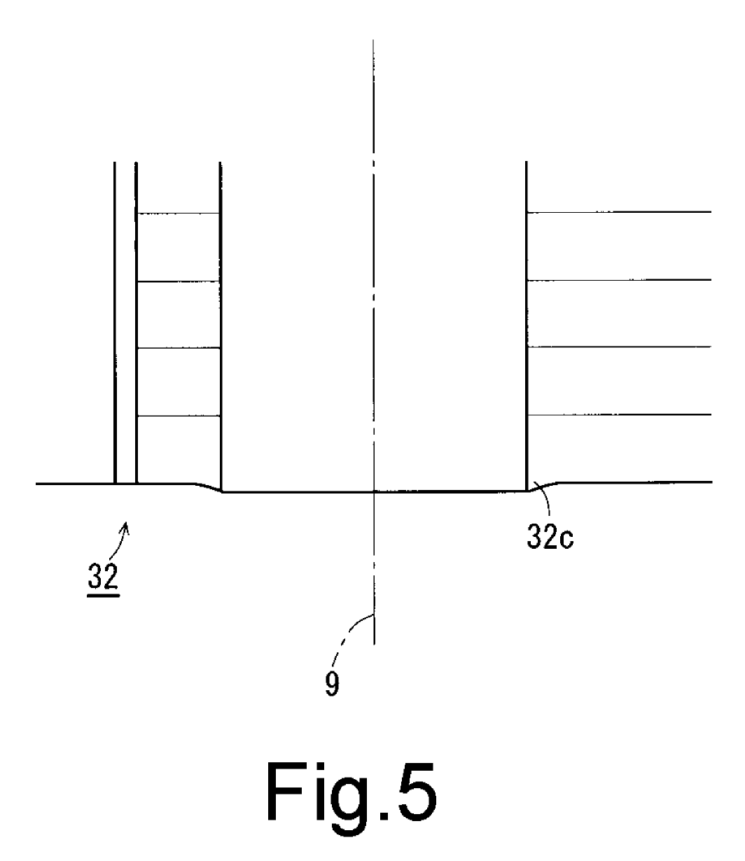

FIG. 4 is an enlarged vertical cross-sectional view illustrating a central portion of an upper end portion of the rotor core 32. FIG. 5 is an enlarged vertical cross-sectional view illustrating a central portion of a lower end portion of the rotor core 32. The rotor core 32 is preferably obtained by stamping laminated steel sheets in the axial direction through press working, for example. As illustrated in FIG. 4, an edge portion of the central through hole 32a on an upper surface of the rotor core 32 includes a rounded portion 32b defined as a result of the press working. The rounded portion 32b is a so-called rollover. Meanwhile, as illustrated in FIG. 5, an edge portion of the central through hole 32a on a lower surface of the rotor core 32 includes at least one projection 32c defined as a result of the press working. The projection 32c is a so-called burr.

It is preferable that, when the shaft 31 is press fitted into the rotor core 32, the shaft 31 should be press fitted into the central through hole 32a through the upper surface of the rotor core 32 where the rounded portion 32b is defined. In other words, it is preferable that the direction of the press fitting of the shaft 31 into the rotor core 32 should coincide with the direction of the stamping in the press working of the rotor core 32. This alignment will contribute to a reduction in stresses that are applied to the rotor core 32 and the shaft 31 at the time of the press fitting even if the inner edge portions of the upper and lower surfaces of the rotor core have undergone slight deformations during the stamping process, enabling the shaft 31 to be smoothly press fitted into the rotor core 32. The rotor core 32 and the shaft 31 are thereby substantially prevented from undergoing any damage during the press fitting. Moreover, an improvement is achieved in precision with which the shaft 31 is positioned relative to the rotor core 32.

FIG. 6 is a top view of the rotor core 32. A section of the rotor core 32 illustrated in FIG. 3 is taken along line III-III of FIG. 6. As illustrated in FIG. 6, the rotor core 32 preferably further includes a plurality of first through holes 41a to 41j and a plurality of second through holes 42a, 42e, and 42g. Each of the first through holes 41a to 41j and the second through holes 42a, 42e, and 42g is arranged to extend through the rotor core 32 in the axial direction.

The first through holes 41a to 41j are arranged in the circumferential direction and radially outward of the central through hole 32a and radially inward of the rotor magnets 33. Providing the first through holes 41a to 41j in the rotor core 32 contributes to a reduction in weight of the rotor core 32 compared with the case where the first through holes 41a to 41j are not provided. This reduction in weight further results in a decrease in the moment of inertia of the rotating portion 3 which further contributes to a reduction in a time required for the rotating portion 3 to reach a constant speed of rotation once the rotating portion 3 starts rotating.

Each of the first through holes 41a to 41j preferably has substantially the same shape. The first through holes 41a to 41j are arranged at regular intervals in the circumferential direction. The first through holes 41a to 41j as a whole are arranged to be symmetrical with respect to imaginary planes 91 including the central axis 9. FIG. 6 shows two such imaginary planes 91 with respect to which the first through holes 41a to 41j are arranged to be symmetrical. Note, however, that besides the two imaginary planes 91 there are several more of such imaginary planes 91 in the rotor core 32 with respect to which the first through holes 41a to 41j are arranged to be symmetrical.

The second through holes 42a, 42e, and 42g are arranged radially inward of the first through holes 41a, 41e, and 41g, respectively. As illustrated in FIG. 6, the second through hole 42a is arranged radially inward of an inner circumference of the first through hole 41a. The second through hole 42a is preferably defined by a space continuous with the first through hole 41a. The second through hole 42e is arranged radially inward of an inner circumference of the first through hole 41e. The second through hole 42e is preferably defined by a space continuous with the first through hole 41e. The second through hole 42g is arranged radially inward of an inner circumference of the first through hole 41g. The second through hole 42g is preferably defined to be continuous with the first through hole 41g. In short, the second through holes 42a, 42e, and 42g are preferably continuously provided with the first through holes 41a, 41e, and 41g, respectively.

Referring to FIG. 6, the second through hole 42a is a space defined by an inner surface substantially in the shape of a semi-cylinder. The second through hole 42e is a space defined by an inner surface substantially in the shape of a triangular prism. The second through hole 42g is a space defined by an inner surface substantially in the shape of a quadrangular prism. That is, in the present preferred embodiment, each of the second through holes 42a, 42e, and 42g has a different shape with respect to others of the through holes 42a, 42e, and 42. As a result, the configuration of the second through holes 42a, 42e, and 42g as a whole is not symmetrical with respect to any imaginary plane 91 including the central axis 9. A through hole group 40 is made up of the first through holes 41a to 41j and the second through holes 42a, 42e, and 42g. Therefore, the configuration of the through hole group 40 is also not symmetrical with respect to any imaginary plane 91 including the central axis 9.

The configurations of opening ends of the second through holes 42a, 42e, and 42g on the upper and lower surfaces of the rotor core 32 when viewed in the axial direction do not coincide with each other. Also, the configurations of the through hole group 40 on the upper and lower surfaces of the rotor core 32 when viewed in the axial direction do not coincide with each other. This enables the manufacturer, the assembly machine, or the like to distinguish between the upper and lower surfaces of the rotor core 32 by identifying the configuration of the second through holes 42a, 42e, and 42g or the configuration of the through hole group 40 including the second through holes 42a, 42e, and 42g on each of the upper and lower surfaces of the rotor core 32 during a process of manufacturing the motor 1.

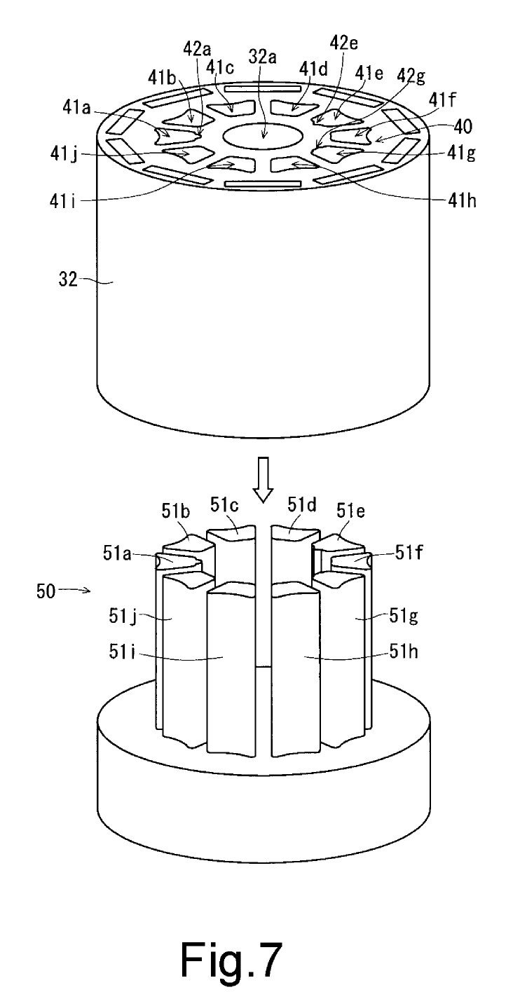

A discrimination-use jig 50 as illustrated in FIG. 7 may be used when the manufacturer, the assembly machine, or the like distinguishes between the upper and lower surfaces of the rotor core 32. In FIG. 7, the discrimination-use jig 50 includes a plurality of columnar portions 51a to 51j arranged to match the configuration of the through hole group 40. The configurations of the through hole group 40 on the upper and lower surfaces of the rotor core 32 when viewed in the axial direction do not coincide with each other. Therefore, the columnar portions 51a to 51j can be inserted into the rotor core 32 through only one of the upper and lower surfaces of the rotor core 32. The manufacturer, the assembly machine, or the like is able to distinguish between the upper and lower surfaces of the rotor core 32 depending on whether an attempt to insert the columnar portions 51a to 51j into the through hole group 40 succeeds or not.

Use of the discrimination-use jig 50 as described above enables the manufacturer or the like to distinguish between the upper and lower surfaces of the rotor core 32 more securely, excluding unreliability of visual inspection. After distinguishing between the upper and lower surfaces of the rotor core 32, the manufacturer, the assembly machine, or the like is able to press fit the shaft 31 into the rotor core 32 in the appropriate direction based on the discrimination.

Moreover, a press-fit jig may be used to correct an inclination of the shaft 31 with respect to the rotor core 32 when the shaft 31 is press fitted into the rotor core 32. When the press-fit jig is used, a portion of the press-fit jig is inserted into one of the through holes of the rotor core 32. Notice here that, in the present preferred embodiment, each of the second through holes 42a, 42e, and 42g has a different shape. Accordingly, one of the second through holes 42a, 42e, and 42g may be used as a reference hole for insertion of the press-fit jig. The inclination of the shaft 31 with respect to the rotor core 32 can be corrected by inserting a portion of the press-fit jig into the reference hole.

In FIG. 6, each of the second through holes 42a, 42e, and 42g is smaller than each of the first through holes 41a to 41j. Therefore, even in the case where the second through holes 42a, 42e, and 42g are arranged at irregular intervals in the circumferential direction and have mutually different shapes, the second through holes 42a, 42e, and 42g are unlikely to cause a displacement of the center of gravity of the rotor core 32. The rotor core 32 according to the present preferred embodiment is configured to reduce the displacement of the center of gravity from the central axis 9 while making it possible to distinguish between the upper and lower surfaces thereof.

In particular, in the case where the discrimination-use jig 50 as illustrated in FIG. 7 is used, it is possible to reduce the size of each of the second through holes 42a, 42e, and 42g to the extent that it becomes difficult to distinguish between the upper and lower surfaces of the rotor core 32 through a visual inspection, for example. When the size of each of the second through holes 42a, 42e, and 42g is reduced to such an extent, an additional reduction is achieved in the displacement of the center of gravity of the rotor core 32 owing to the second through holes 42a, 42e, and 42g.

Furthermore, referring to FIG. 6, a space 92 is defined by three imaginary surfaces that join three of the second through holes 42a, 42e, and 42g to one another. In the present preferred embodiment, the space 92 defined by the three imaginary surfaces is a space substantially in the shape of a triangular prism. The central axis 9 is located within the space 92. This means that the second through holes 42a, 42e, and 42g are arranged around the central axis 9 with a small degree of imbalance. In particular, unevenness in radial mass distribution of the rotor core 32 is substantially limited. The above-described arrangement of the second through holes 42a, 42e, and 42g contributes to an additional reduction in the displacement of the center of gravity of the rotor core 32 owing to the second through holes 42a, 42e, and 42g.

Furthermore, in the present preferred embodiment, each of the first through holes 41a to 41j and the second through holes 42a, 42e, and 42g is arranged to extend through the rotor core 32 in the axial direction. This contributes to substantially limited unevenness in axial mass distribution of the rotor core 32.

The rotor magnets 33 generate magnetic circuits 33a within the rotor core 32. The magnetic circuits 33a are generated substantially in the shape of circular arcs projected radially inward between adjacent ones of the rotor magnets 33. In FIG. 6, only the magnetic circuits 33a which are generated between one pair of adjacent ones of the rotor magnets 33 are shown. Note, however, that similar magnetic circuits 33a are also generated between every other pair of adjacent ones of the rotor magnets 33.

In the present preferred embodiment, the rotor core 32 preferably includes the same number of first through holes 41a to 41j as that of rotor magnets 33. Each of the first through holes 41a to 41j is arranged radially inside a boundary between a separate pair of adjacent ones of the rotor magnets 33. A radially outer surface 43 within those surfaces which define each of the first through holes 41a to 41j is curved radially inward along the aforementioned magnetic circuits 33a when viewed in the axial direction. This contributes to securing a larger space for the magnetic circuits 33a radially outside each of the first through holes 41a to 41j.

Furthermore, the second through holes 42a, 42e, and 42g are arranged radially inward of the first through holes 41a, 41e, and 41g, respectively. Therefore, providing the second through holes 42a, 42e, and 42g does not narrow portions of the rotor core 32 which are radially outward of the first through holes 41a to 41j. Therefore, sufficiently large spaces for the magnetic circuits 33a are secured radially outside the first through holes 41a to 41j. While preferred embodiments of the present invention have been described above, it should be noted that the present invention is not limited to the above-described preferred embodiments. A variety of example modifications thereof will now be described below with a focus on differences from the above-described preferred embodiments.

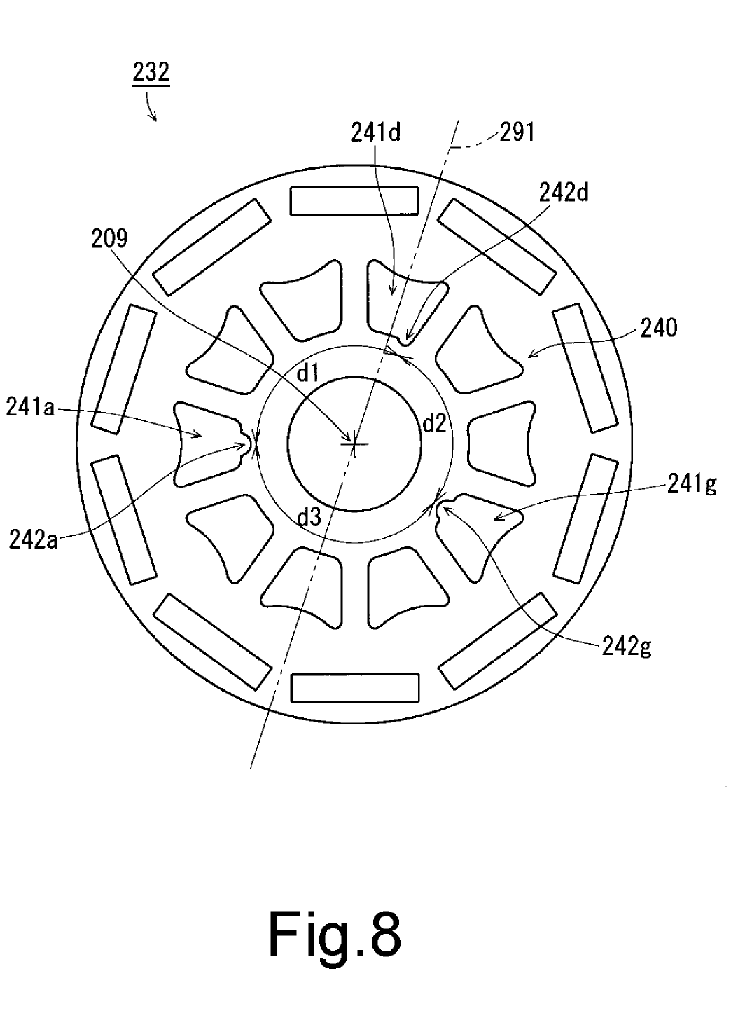

FIG. 8 is a top view of a rotor core 232 according to an example modification of the above-described preferred embodiments. In FIG. 8, a plurality of second through holes 242a, 242d, and 242g are arranged radially inward of a plurality of first through holes 241a, 241d, and 241g, respectively. The second through holes 242a, 242d, and 242g are continuous with the first through holes 241a, 241d, and 241g, respectively.

Each of the second through holes 242a and 242g, that is, two of the three second through holes 242a, 242d, and 242g, is defined by a surface substantially in the shape of a semi-cylinder. The remaining second through hole 242d preferably has a substantially different configuration from that of the other two second through holes 242a and 242g. Here, the second through hole 242d is arranged substantially in the shape of a semi-cylinder, but has a slightly smaller volume than that of each of the other two second through holes 242a and 242g. In addition, the second through hole 242d is arranged at a position displaced from a circumferential center of the first through hole 241d.

In FIG. 8, a circumferential distance d1 between the second through holes 242a and 242d, a circumferential distance d2 between the second through holes 242d and 242g, and a circumferential distance d3 between the second through holes 242g and 242a are different from one another. Therefore, the configuration of the second through holes 242a, 242d, and 242g, and hence the configuration of a through hole group 240 including the second through holes 242a, 242d, and 242g, are not symmetrical with respect to any imaginary plane including a central axis 209.

Therefore, the configurations of the second through holes 242a, 242d, and 242g, and hence the configurations of the through hole group 240 including the second through holes 242a, 242d, and 242g, on upper and lower surfaces of the rotor core 232 when viewed in the axial direction do not coincide with each other. This enables the manufacturer, the assembly machine, or the like to distinguish between the upper and lower surfaces of the rotor core 232 when assembling the motor. As described above, two or more of the second through holes may have the same shape, as long as the second through holes as a whole are arranged to have an asymmetrical configuration.

Note that, in FIG. 8, the shape of a combination of the first through hole 241d and the second through hole 242d as being continuous with each other is not symmetrical with respect to an imaginary plane 291 including the central axis 209. Therefore, even if the other two second through holes 242a and 242g are absent, the configuration of the through hole group 240 is not symmetrical with respect to any imaginary plane including the central axis 209. Even in this case, the manufacturer, the assembly machine, or the like is able to distinguish between the upper and lower surfaces of the rotor core 232 when assembling the motor.

That is, the rotor core 232 including at least one second through hole in addition to the first through holes may be enough for different configurations of the upper and lower surfaces of the rotor core 232 when viewed in the axial direction. In the case where only one second through hole is provided, it may be enough that the shape of the second through hole or the shape of a combination of the second through hole and a first through hole that is continuous therewith should not be symmetrical with respect to any imaginary plane including the central axis. Note, however, that it is preferable that two or more second through holes should be arranged around the central axis 209 in order to reduce the displacement of the center of gravity of the rotor core owing to the second through hole(s).

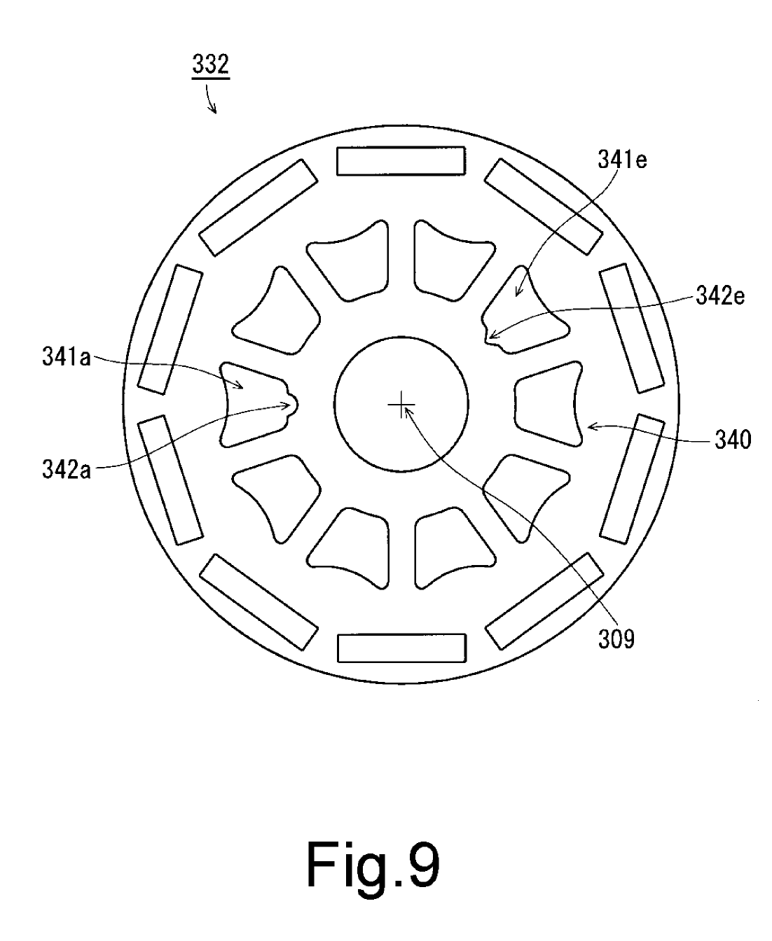

FIG. 9 is a top view of a rotor core 332 according to another example of a modification of the above-described preferred embodiments. In FIG. 9, a plurality of second through holes 342a and 342e are arranged radially inward of a plurality of first through holes 341a and 341e, respectively. The second through holes 342a and 342e are arranged to be continuous with the first through holes 341a and 341e, respectively.

The shape of the second through hole 342a and the shape of the second through hole 342e are substantially different from each other. In addition, the second through holes 342a and 342e are not spaced approximately 180 degrees apart from each other with respect to a central axis 309. In other words, the second through hole 342a is preferably spaced less than 180 degrees apart from the second through hole 342e with respect to the central axis 309. Therefore, the configuration of the plurality of second through holes 342a and 342e is not symmetrical with respect to any imaginary plane including the central axis 309. A through hole group 340 preferably includes the plurality of second through holes 342a and 342e. The configuration of the through hole group 340 is not symmetrical with respect to any imaginary plane including the central axis 309.

Therefore, the configurations of the plurality of second through holes 342a and 342e on upper and lower surfaces of the rotor core 332 when viewed in the axial direction do not coincide with each other. The through hole group 340 includes the plurality of second through holes 342a and 342e. The configurations of the through hole group 340 on the upper and lower surfaces of the rotor core 332 do not coincide with each other. This enables the manufacturer, the assembly machine, or the like to distinguish between the upper and lower surfaces of the rotor core 332 when assembling the motor.

In the case where only two second through holes are defined in the rotor core as in FIG. 9, it is preferable that the two second through holes should be spaced approximately 90 or more degrees apart from each other with respect to the central axis. This will reduce imbalance of the second through holes around the central axis which will in turn reduce the displacement of the center of gravity of the rotor core owing to the second through holes. It is more preferable that the two second through holes should be spaced about 120 or more degrees apart from each other with respect to the central axis. It is still more preferable that the two second through holes should be spaced about 150 or more degrees apart from each other with respect to the central axis. In short, it is preferable that the two second through holes should be arranged in the rotor core within an angular range of about 90 degrees to about 180 degrees from each other with respect to the central axis.

Meanwhile, in the case where three or more second through holes are defined in the rotor core, it is preferable that the central axis should be located within a space in the shape of a polygonal column which is defined by imaginary surfaces that join the three or more second through holes to one another. This will reduce an imbalance of the second through holes around the central axis which will in turn reduce displacement of the center of gravity of the rotor core owing to the second through holes. In the case where the shapes of the individual second through holes suffice for asymmetrical configuration of the second through holes, it is more preferable that the second through holes should be arranged at regular intervals around the central axis.

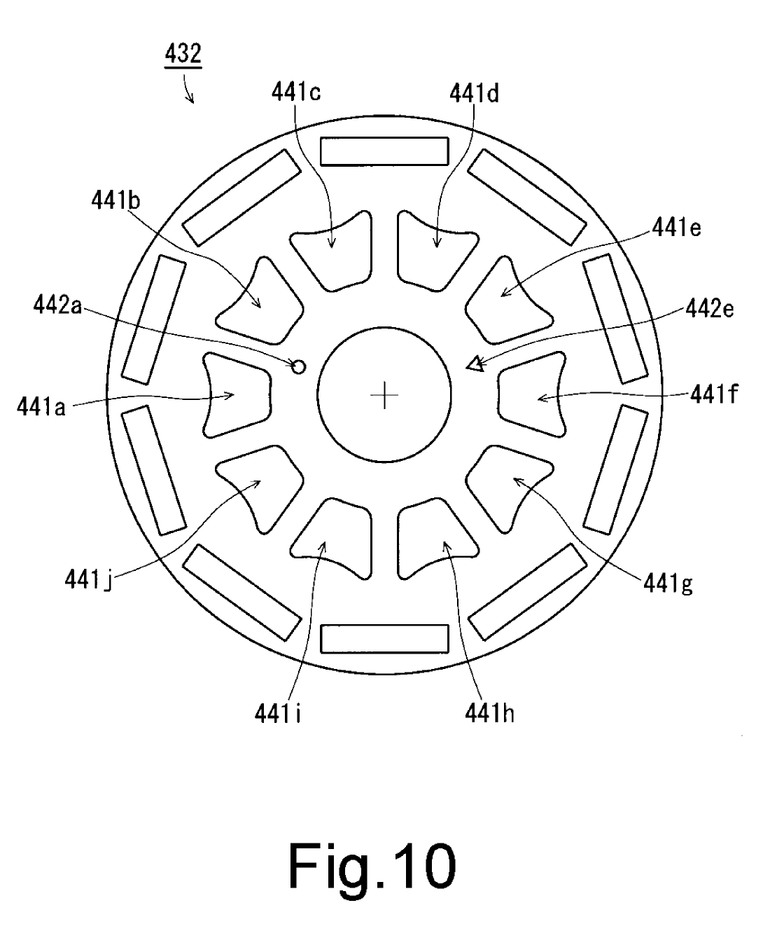

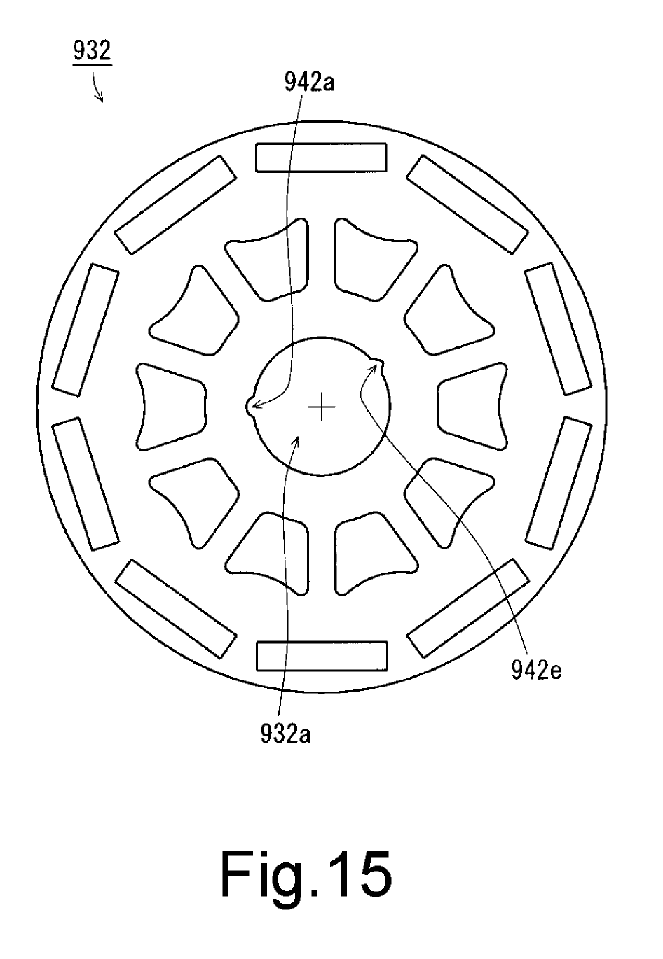

Note that each of the second through holes may not necessarily be arranged to be continuous with one of the first through holes. In other words, one or more of the second through holes may be spaced away from the first through holes if so desired. For example, in a rotor core 432 according to a preferred embodiment of the present invention illustrated in FIG. 10, two second through holes 442a and 442e are defined independently of a plurality of first through holes 441a to 441j. Also, one or more second through holes may be defined continuously with the central through hole. For example, in a rotor core 932 according to a preferred embodiment of the present invention illustrated in FIG. 15, two second through holes 942a and 942e are defined continuously with a central through hole 932a. Also, one or more second through holes may be defined continuously with a through hole(s) in which a rotor magnet(s) is arranged.

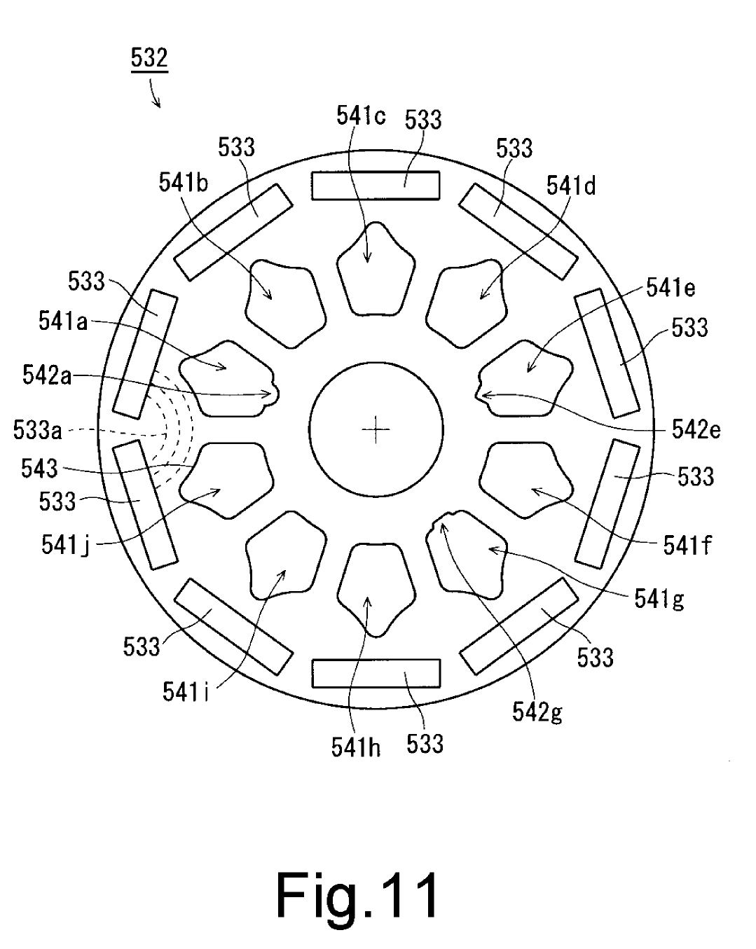

FIG. 11 is a top view of a rotor core 532 according to yet another example modification of the above-described preferred embodiments. In FIG. 11, a plurality of first through holes 541a to 541j is arranged at the same circumferential positions as those of rotor magnets 533. In FIG. 11, a radially outer surface 543 within those surfaces which define each of the first through holes 541a to 541j includes a portion curved radially inward to extend along magnetic circuits 533a when viewed in the axial direction in a space radially inside a boundary between a separate pair of adjacent ones of the rotor magnets 533. This contributes to securing a larger space for the magnetic circuits 533a.

Moreover, in FIG. 11, second through holes 542a, 542e, and 542g are arranged radially inward of the first through holes 541a, 541e, and 541g, respectively. This contributes to securing sufficient spaces for the magnetic circuits within the rotor core 532 radially outside the first through holes 541a to 541j.

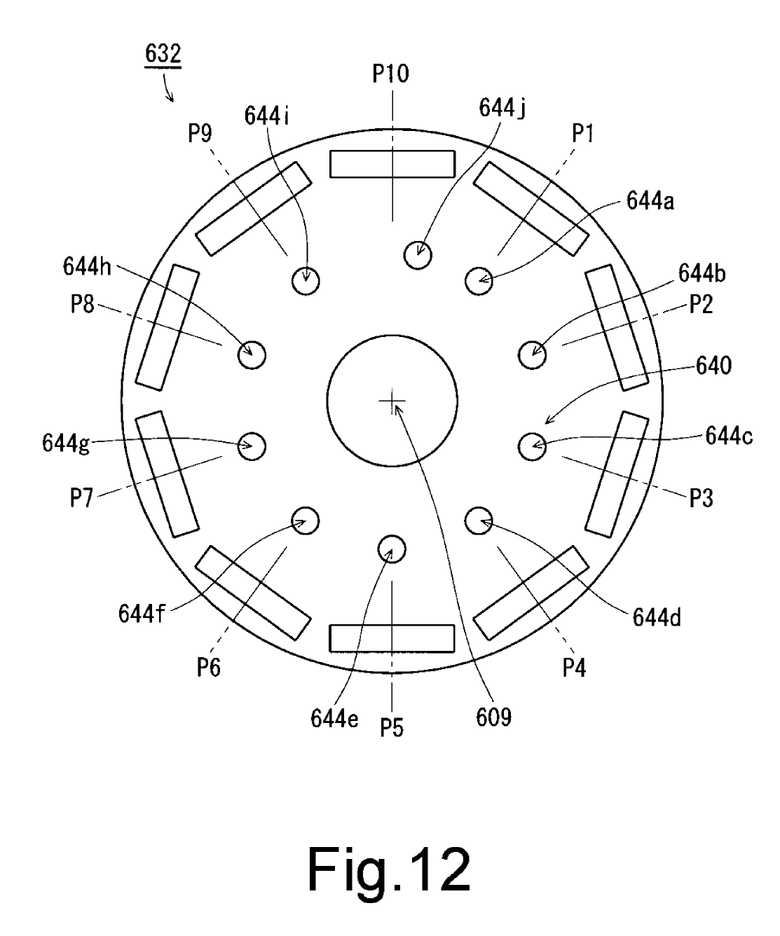

FIG. 12 is a top view of a rotor core 632 according to yet another example modification of the above-described preferred embodiments. In FIG. 12, the rotor core includes a plurality of third through holes and at least one fourth through hole defined therein. The third through holes are arranged at equiangular positions which are points that divide a circumference of a circle centered on a central axis into a plurality of equal parts. The fourth through hole preferably is arranged at a position displaced from the equiangular positions. In FIG. 12, each of the third through holes has the same shape as that of the fourth through hole. The rotor core 632 preferably includes, for example, one fourth through hole 644j and nine third through holes 644a to 644i arranged in the circumferential direction defined therein. In FIG. 12, equiangular positions P1 to P10 are points that divide a circumference of a circle centered on a central axis 609 into ten equal portions. The nine third through holes 644a to 644i are arranged at the equiangular positions P1 to P9, respectively. The fourth through hole 644j is arranged at a position substantially displaced from the remaining equiangular position P10.

A through hole group 640 preferably includes the third through holes 644a to 644i and the fourth through hole 644j. Therefore, the through hole group 640 as a whole is not symmetrical with respect to any imaginary plane including the central axis 609. Therefore, the configurations of the through hole group 640 on upper and lower surfaces of the rotor core 632 when viewed in the axial direction do not coincide with each other. This enables the manufacturer, the assembly machine, or the like to distinguish between the upper and lower surfaces of the rotor core 632 when assembling the motor, for example.

Furthermore, the nine third through holes 644a to 644i are preferably arranged at the equiangular positions P1 to P9, respectively. This arrangement contributes toward reducing the displacement of the center of gravity of the rotor core 632. Note that the number of third through holes included in the through hole group 640 may be any desirable number in a range of 2 to 8 or greater than 9. Also note that the number of fourth through holes may be greater than one if so desired. In short, the through hole group 640 includes a plurality of third through holes and at least one fourth through hole.

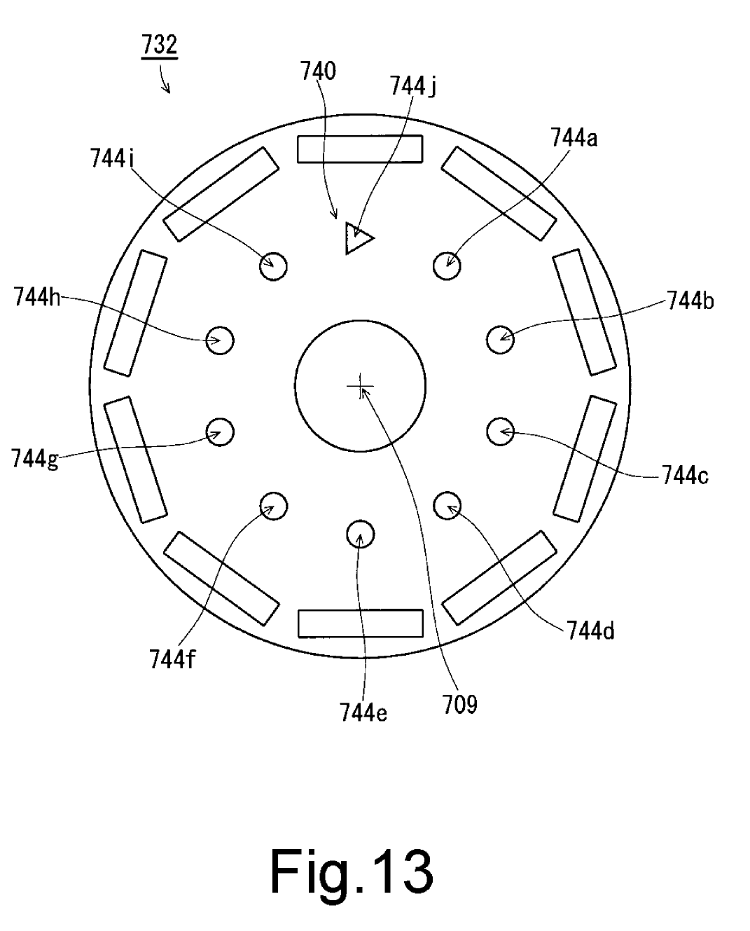

FIG. 13 is a top view of a rotor core 732 according to yet another example modification of the above-described preferred embodiments. The rotor core 732 includes a plurality of through holes 744a to 744j arranged in the circumferential direction defined therein. In FIG. 13, the number of through holes is ten. Of the through holes 744a to 744j, at least one through hole preferably has a substantially different shape from that of the other through holes. In FIG. 13, nine of the ten through holes 744a to 744j, that is, the through holes 744a to 744i are each a space substantially in the shape of a column. The remaining through hole 744j is a space substantially in the shape of a triangular prism, and arranged not to be symmetrical with respect to any imaginary plane including a central axis 709.

A through hole group 740 preferably includes the plurality of through holes 744a to 744j. Therefore, the through hole group 740 as a whole is not symmetrical with respect to any imaginary plane including the central axis 709. Therefore, the configurations of the through hole group 740 on upper and lower surfaces of the rotor core 732 when viewed in the axial direction do not coincide with each other. This enables the manufacturer, the assembly machine, or the like to distinguish between the upper and lower surfaces of the rotor core 732.

Furthermore, the through holes 744a to 744j are arranged at regular intervals around the central axis 709. Therefore, a displacement of the center of gravity of the rotor core 732 owing to the through holes 744a to 744j is substantially limited. Note that the number of through holes included in the through hole group 740 may not necessarily be ten, but may be in a range of 1 or more. Also note that the number of fourth through holes that contribute to an asymmetrical configuration of the through hole group may be greater than one. The through hole 744j illustrated in FIG. 13 is an example of such a fourth through hole.

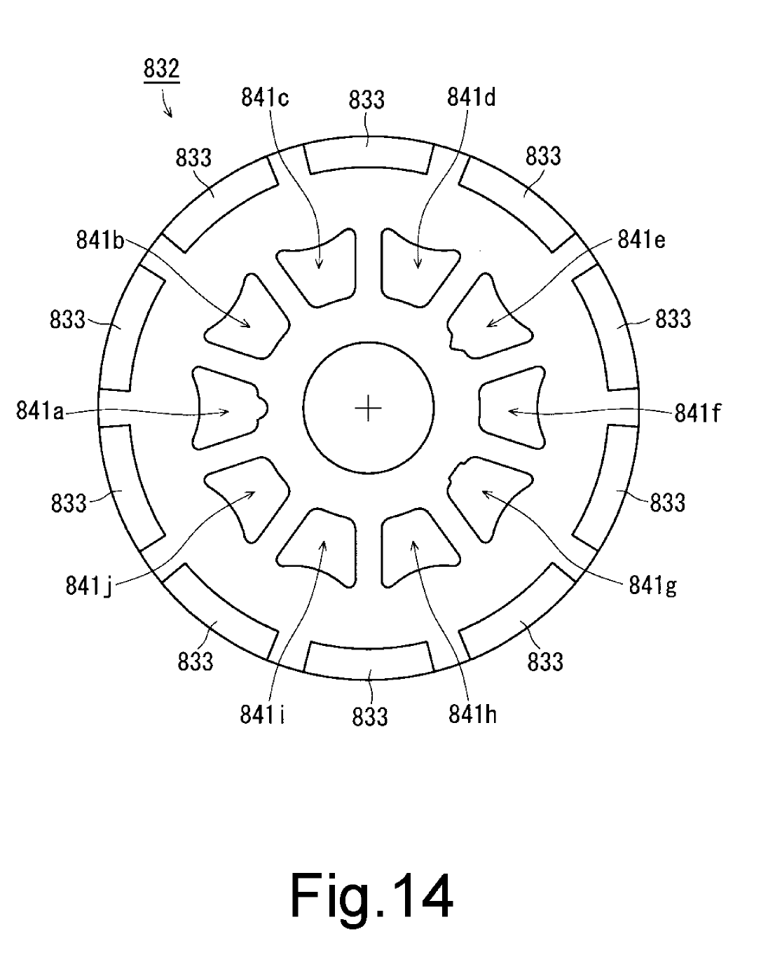

FIG. 14 is a top view of a rotor core 832 according to yet another example modification of the above-described preferred embodiments. In FIG. 14, a plurality of rotor magnets 833 are arranged in the circumferential direction on an outer circumferential surface of the rotor core 832. In FIG. 14, the rotor magnets 833 are arranged at regular intervals in the circumferential direction. An outer circumferential surface of each of the rotor magnets 833 is exposed on an exterior of the rotor core 832. The above arrangement contributes to securing larger spaces for magnetic circuits generated by the rotor magnets 833 radially outside first through holes 841a to 841j. An outside surface of each of the rotor magnets 833 is arranged at the same radial position as that of an outside surface of the rotor core 832. Preferred embodiments of the present invention are applicable to rotary electric machines, for example. Rotary electric machines according to preferred embodiments of the present invention may preferably be, for example, motors for use in power-assisted bicycles or motors for use in electric motorcycles, electric wheelchairs, automobiles, lawn mowers, pressure washers, and so on. Moreover, it is also possible to construct generators that have structures equivalent to those of the motors according to the above-described preferred embodiments and the example modifications thereof. Rotary electric machines according to preferred embodiments of the present invention may be generators for use in the power-assisted bicycles or the automobiles, or generators used for wind power generation or the like.

Note that features of the above-described preferred embodiments and the example modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A rotary electric machine comprising:
a stationary portion; and
a rotating portion supported to be rotatable with respect to the stationary portion; wherein
the rotating portion includes:
a shaft arranged to extend along a central axis extending in a vertical direction;
a rotor core fixed to the shaft and includes sheets laminated in an axial direction; and
rotor magnets held by the rotor core;
the stationary portion includes:
a bearing portion arranged to support the shaft such that the shaft is rotatable; and
an armature arranged radially outward of the rotor magnets;
the rotor core includes a through hole group including a plurality of through holes extending through the rotor core in the axial direction; and
the through hole group is arranged not to be symmetrical with respect to any imaginary plane that includes the central axis.

2. The rotary electric machine according to claim 1, wherein the plurality of through holes of the through hole group includes:
a plurality of first through holes arranged at regular intervals in a circumferential direction; and
at least one second through hole each having a total volume smaller than that of each first through hole;
the first through holes are arranged to be symmetrical with respect to a plurality of imaginary planes each including the central axis; and
the at least one second through hole is arranged not to be symmetrical with respect to any of the plurality of imaginary planes.

3. The rotary electric machine according to claim 2, wherein
the at least one second through hole included in the through hole group is plural in number; and
each of the second through holes has a different shape.

4. The rotary electric machine according to claim 2, wherein
the at least one second through hole included in the through hole group is two in number; and
the two second through holes are spaced about 90 or more degrees apart from each other with respect to the central axis.

5. The rotary electric machine according to claim 2, wherein
the at least one second through hole included in the through hole group is three or more in number; and
the central axis is located within a space in a shape of a polygonal column which is defined by imaginary surfaces that join the three or more second through holes to one another.

6. The rotary electric machine according to claim 2, wherein each of the at least one second through hole is integrally defined with one of the first through holes.

7. The rotary electric machine according to claim 2, wherein
the rotor magnets are arranged radially outward of the first through holes; and
the at least one second through hole is arranged radially inward of the first through holes.

8. The rotary electric machine according to claim 7, wherein
each of the rotor magnets includes a north pole surface and a south pole surface;
the rotor magnets are arranged in the rotor core such that the north and south pole surfaces of the rotor magnets alternate with each other in the circumferential direction; and
each of the first through holes includes a radially inward recessed surface which is arranged in a space radially inside a boundary between a separate pair of adjacent ones of the rotor magnets.

9. The rotary electric machine according to claim 1, wherein
the plurality of through holes defining the through hole group are arranged in a circumferential direction; and
the plurality of through holes include:
a plurality of through holes arranged at equiangular positions that divide a circumference of a circle centered on the central axis into the same number of equal parts as that of the plurality of through holes; and
at least one through hole each arranged at a position displaced from the equiangular positions.

10. The rotary electric machine according to claim 1, wherein
the plurality of through holes defining the through hole group are arranged at substantially regular intervals in a circumferential direction; and
the plurality of through holes include at least one through hole each having an asymmetrical shape with respect to any imaginary plane including the central axis.

11. The rotary electric machine according to claim 1, wherein the rotor magnets are embedded in the rotor core.

12. The rotary electric machine according to claim 1, wherein the rotor magnets are arranged on an outer circumferential surface of the rotor core.

13. The rotary electric machine according to claim 1, wherein
the stationary portion includes:
a housing including a bottom and being substantially cylindrical; and
a cover portion in a shape of a plate and arranged to close an upper opening of the housing; and
the shaft includes a head portion arranged to project above the cover portion.

14. The rotary electric machine according to claim 1, wherein
the rotor core includes laminated electromagnetic steel sheets;
the rotor core includes a central through hole defined in a center thereof, the central through hole being arranged to have the shaft inserted therein;
an edge portion of the central through hole on an upper surface of the rotor core includes a rounded portion; and
an edge portion of the central through hole on a lower surface of the rotor core includes at least one projection.

15. The rotary electric machine according to claim 3, wherein
the at least one second through hole is three in number;
one of the second through holes is a space in a shape of a semicylinder;
another of the second through holes is a space in a shape of a triangular prism; and
yet another of the second through holes is a space in a shape of a quadrangular prism.

16. The rotary electric machine according to claim 2, wherein
the at least one second through hole is three in number;
two of the second through holes are each a space in a shape of a semicylinder; and
one of the second through holes is a space in the shape of a semicylinder, but has a slightly smaller size than that of each of the other two second through holes.

17. The rotary electric machine according to claim 5, wherein the polygonal column is a triangular prism.

18. The rotary electric machine according to claim 2, wherein
the at least one second through hole is plural in number; and
each pair of adjacent ones of the second through holes has a different circumferential distance therebetween.

19. The rotary electric machine according to claim 2, wherein
the rotor core includes laminated electromagnetic steel sheets;
the rotor core includes a central through hole defined in a center thereof, the central through hole being arranged to have the shaft inserted therein; and
at least one of the at least one second through hole is integrally defined with the central through hole.

20. The rotary electric machine according to claim 2, wherein the first through holes are arranged at the same circumferential positions as those of the rotor magnets.
